(19) United States
(12) Patent Application Publication
(10) Pub. No.: US 2019/0122189 A1
(43) Pub. Date: Apr. 25, 2019

(54) TRANSACTION PROCESSING SYSTEM

(71) Applicant: QuotePro Kiosk, LLC, Chicago, IL (US)

(72) Inventors: Marco Andres Freudman, Chicago, IL (US); Kyle Evan Blair, Westmont, IL (US)

(21) Appl. No.: 16/039,119

(22) Filed: Jul. 18, 2018

Related U.S. Application Data
(60) Provisional application No. 62/576,043, filed on Oct. 23, 2017.

(51) Int. Cl. G06Q 20/10; G06Q 30/04; G06Q 20/08; G06Q 20/14; G06Q 20/40; G06F 21/31

(52) U.S. Cl. CPC G06Q 20/102; G06Q 30/04; G06F 21/31; G06Q 20/145; G06Q 20/4014; G06Q 20/085

(57) ABSTRACT

A method for processing a transaction includes receiving, at a terminal and from a user, a selection of a service provider; receiving authentication credential requirements associated with the selected service provider that facilitate authentication of the user by the service provider; and communicating, to the service provider account server, authentication credentials associated with the user that satisfy the authentication credential requirements. When the user is authenticated, the method includes receiving, from the service provider account server, information indicative of an amount owed on an account with the service provider that is associated with the user. The method further includes receiving, via currency processing hardware of the terminal, currency; and communicating transaction information to the service provider account server that indicates an amount of currency received by the terminal to thereby reduce the amount owed on the account by the user. When an amount of currency received by the terminal exceeds and amount owed on the account, the method includes providing, by the terminal, an amount of currency that corresponds to a difference between the amount of currency received and the amount owed on the account.

### RELATED APPLICATIONS

This application claims priority under 35 U.S.C. § 119 to U.S. Provisional Patent Application No. 62/576,043, filed Oct. 23, 2017, the contents of which are hereby incorporated in their entirety.

### BACKGROUND

### Field

This application generally relates to computer accounting systems. In particular, this application describes a transaction processing system.

### Description of Related Art

Service providers such as utility services, loan services, retail establishment services, government agencies, etc. typically send out bills for services rendered on a periodic basis. Many customers pay the bills by sending a check to the service provider. In some cases, customers direct their bank to transfer funds electronically to the service provider. In other cases, the service provider is authorized ahead of time by the customer to draw funds directly from the customer's account.

The process of paying bills is relatively straight forward for those customers having bank accounts and means for electronically viewing account information and for electronically transferring funds.

For those customers lacking these means, the process is more burdensome. For example, a customer without a bank account may have to resort to paying bills with cash or by money order. Not only is this burdensome, but this results in transaction processing delays, which may result in late or missed payments. This and other problems will become apparent upon reading the description below.

### SUMMARY

In a first aspect, a terminal for processing transactions includes a user interface configured to convey information to a user and to receive user commands; currency processing hardware configured to receive currency from the user and to determine a type of currency accepted; a processor in communication with the user interface and the currency processing hardware; and non-transitory computer readable media in communication with the processor that stores instruction code executable by the processor. When executed by the processor, the instruction code causes the processor to receive, via the user interface, an account category selection and communicate the account category selection to a back-end server. The processor then receives, from the back-end server, a listing of service providers associated with the account category selection and conveys on the user interface the listing. The processor receives, via the user interface, a service provider selection and communicates the selection to a back-end server. The processor then receives, from the back-end server, authentication requirements associated with an account server that is associated with the service provider selection, and conveys controls on the user interface that facilitate specification of the authentication requirements by the user. The processor communicates specified requirements to the back-end server. In response, the back-end server communicates the specified requirements to the account server and the account server communicates a listing of one or more services provided by the account server to the back-end server. The processor receives the listing of services provided by the account server from the back-end server and receives, via the user interface, a service selection. The processor then communicates the service selection to the back-end server. In response, the back-end server communicates the service selection to the account server and the account server communicates service information associated with the service selection to the back-end server. The processor receives the service selection from the back-end server. The processor then receives, via the interface, an indication of an amount of currency to be paid and receives currency via the currency processing hardware. The processor then communicates the amount of currency received to the back-end server. In response, the back-end server communicates and indication of the amount of currency received to the account server.

In a second aspect, a method for processing a transaction includes receiving, at a terminal and from a user, a selection of a service provider; receiving authentication credential requirements associated with the selected service provider that facilitate authentication of the user by the service provider; and communicating, to the service provider account server, authentication credentials associated with the user that satisfy the authentication credential requirements. When the user is authenticated, the method includes receiving, from the service provider account server, information indicative of an amount owed on an account with the service provider that is associated with the user. The method further includes receiving, via currency processing hardware of the terminal, currency; and communicating transaction information to the service provider account server that indicates an amount of currency received by the terminal to thereby reduce the amount owed on the account by the user. When an amount of currency received by the terminal exceeds and amount owed on the account, the method includes providing, by the terminal, an amount of currency that corresponds to a difference between the amount of currency received and the amount owed on the account.

In a third aspect, a non-transitory computer readable medium that includes instruction code for processing a transaction is provided. The instruction code is executable on a machine for causing the machine to perform acts that include receiving, from a user, a selection of a service provider; receiving authentication credential requirements associated with the selected service provider that facilitate authentication of the user by the service provider; and communicating, to the service provider account server, authentication credentials associated with the user that satisfy the authentication credential requirements. When the user is authenticated, the machine receives, from the service provider account server, information indicative of an amount owed on an account with the service provider that is associated with the user; receives, via currency processing hardware of the machine, currency; and communicates transaction information to the service provider account server that indicates an amount of currency received by the machine to thereby reduce the amount owed on the account by the user. When an amount of currency received by the machine exceeds and amount owed on the account, the machine provides an amount of currency that corresponds to a difference between the amount of currency received and the amount owed on the account.

### BRIEF DESCRIPTION OF THE DRAWINGS

FIG. 1 illustrates an exemplary environment that includes a transaction processing system that facilitate processing transactions;

FIG. 2 illustrates an exemplary flow diagram associated with the exemplary environment; and

FIGS. 3A-3C illustrate exemplary transaction information generated by the transaction processing system; and

FIG. 4 illustrates an exemplary computer system that may form part of or implement the systems described in the figures or in the following paragraphs.

### DETAILED DESCRIPTION

A system for processing transactions is described below. The system includes a kiosk through which a customer interacts. The kiosk communicates with a back-end-server, which in turn receives information from account servers of customer service providers to obtain customer account information, such as balances, due dates, etc. The customer is able to pay down the accounts through the kiosk and receive change from the kiosk.

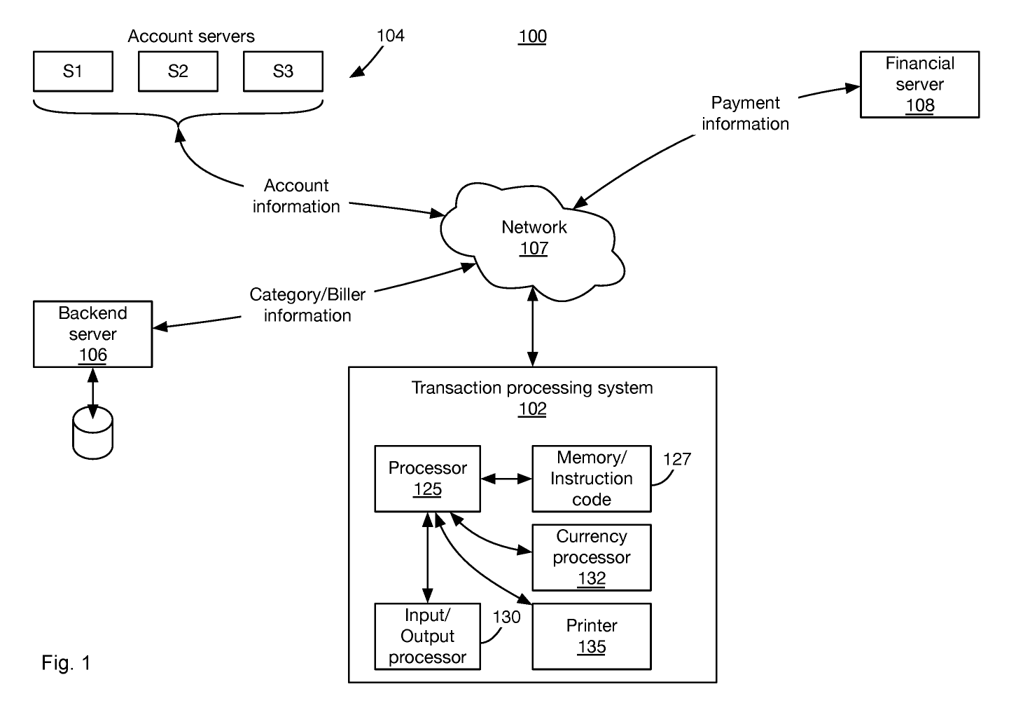

FIG. 1 illustrates an exemplary environment 100 that includes various systems/devices that facilitate processing transactions, such as bill payment transactions. The systems/devices may be owned, jointly owned and/or operated by organizations, such as corporations, government agencies, institutions, individuals, etc.

Exemplary systems/devices of the environment 100 include a transaction processing system 102, an exemplary group of account servers 104 associated with related service providers, a back-end server 106, and a financial server 108. The various systems and servers may communicate with one another via a network 107, such as the Internet.

The account servers 104, back-end server 106, and financial server 108 may correspond to computer systems such as an Intel®, AMD®, or PowerPC® based computer system or a different computer system and can include application specific computer systems. The computer systems may include an operating system, such as Microsoft Windows®, Linux, Unix® or other operating system. The servers may include one or more API's that facilitate communicating information to and from the respective severs. For example, the API may correspond to a web services API, RESTful API, SOAP API, and/or a different API.

The account servers 104 correspond to systems for managing billing accounts associated with a service provider. For example, a utility company may have an account server that facilitates viewing information such as a bill, account balance, etc. The account server 104 may also facilitate paying a bill and/or marking a bill as having been paid.

The number of account servers 104 illustrated is merely exemplary. It is understood that there may be any number of billing servers, the number corresponding to the number of services and/or service providers for which transactions may be processed. For example, the account servers 104 may include any number of account servers associated with servicer providers such as utility services, loan services, retail establishment services, government agencies, etc.

The financial server 108 may correspond to a system that facilitates routing payments received via the transaction processing system 102 to a corresponding service provider. In one implementation the financial server 108 is managed by an organization that provides services to leasing and finance companies, banks, credit unions, etc., and the financial server 108 provides account-to-account transfer applications to facilitate routing currency between parties.

The back-end server 106 stores information specific to the various account servers. For example, the back-end server 106 may include databases that includes one or more records, where each record may be related to a given account server and/or service provider that owns/operates the account server. Table 1 below illustrates an exemplary set of records that may be stored in the database.

TABLE 1

| Service | | Server IP | | Authentication |
|---|---|---|---|---|
| provider | Category | address | Capabilities | Requirements |
| Electric Co. | Utility | 111.222.333.444 | Lookup | Two or more of: Name |
| | | | | on account, zip code for |
| | | | | account holder, SSN of |
| | | | | account holder |
| Gas Co. | Utility | 222.111.333.444 | Blind push | Name, Account Number, |
| | | | | and Amount |
| . . . | . . . | . . . | . . . | . . . |

Referring to Table 1, a first record associated with a service provider may specify the name of the service provider, the IP address for the account server associated with the service provider, capabilities, and requirements associated with the account server. The capabilities field indicates the capabilities of the account server. For example, a server with lookup capabilities may be capable of providing account information, such as a current balance, and amount owed for the current billing cycle, etc. A server with blind push capabilities may be unable to provide such information.

The authentication requirements field indicates the information needed by the account server to authenticate and process information. For example, a first account server may require two items of information to facilitate access to information provided by the account server, such as the name on account, zip code and/or SSN of account holder. This type of server may be less cumbersome to deal with in that the information required may be relatively easy to remember. On the other hand, the second server may require the name on the account along with the account number, and an amount to be paid.

The transaction processing system (TPS) 102 may correspond to a terminal device such as a kiosk that may be located in a business establishment, such as a bank, car dealer, or elsewhere. The TPS 102 includes a processor 125, a non-transitory computer readable medium 127 that stores instruction code executed by the processor 125. The TPS 102 also includes various subsystems such as an input/output (I/O) processor 130, currency processing hardware 132, and a printer 135.

The I/O processor 130 is configured to facilitate communications with entities outside of the TPS 102. In this regard, the I/O processor 110 may be configured to dynamically determine the communication methodology utilized by entities of the environment 100 for communicating information to the entities using the determined communication methodology. For example, the I/O processor 110 may determine that a first entity utilizes a RESTful API and may, therefore, communicate with the entity using a RESTful communication methodology. As described in more detail below, the I/O processor 110 may generate one or more interfaces through which users may interact with the TPS 102.

The currency processing hardware 132 corresponds to a device capable of receiving currency, determine the value of the currency, and optionally providing change. For example, the currency processing hardware 132 may include a slot through which currency is inserted. The currency processing hardware 132 may include a scanning system to analyze the currency for determining the value of the currency. Bank notes of different face values may be stored within the currency processing hardware 132 to facilitate providing change.

The printer 135 corresponds to any device capable of producing a print out. In this regarding the printer 135, may correspond to a dot matrix printer, thermal printer, inkjet printer, etc. The printer 135 may be operable to print a receipt, a current balance, and other information that may be requested by a user.

The processor 125 executes instruction code stored in a memory device 127 for coordinating activities performed between the various subsystems. The processor 125 may correspond to a stand-alone computer system such as an Intel®, AMD®, or PowerPC® based computer system or a different computer system and can include application specific computer systems. The computer systems may include an operating system, such as Microsoft Windows®, Linux, Unix® or other operating system.

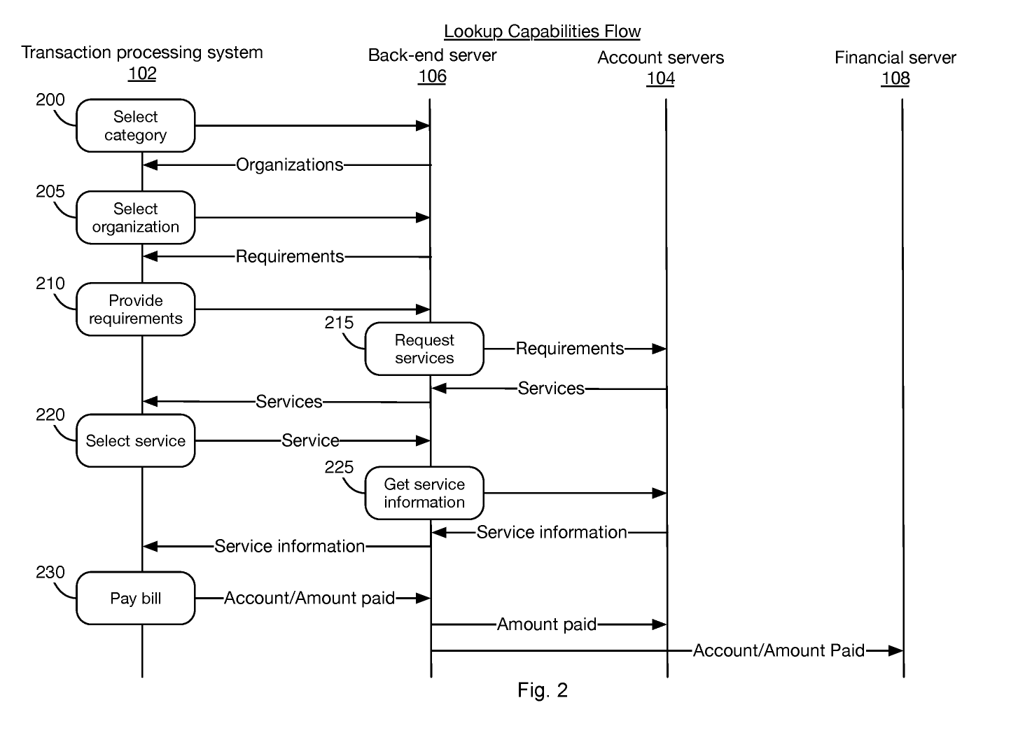

Exemplary operations performed by one or more of the subsystems of the TPS 102 in processing a transaction are illustrated in FIG. 2. In this regard, the operations may be implemented via instruction code stored in non-transitory computer readable media 127 that resides within the TPS 102, one or more of the subsystems of the TPS 102, and one or more of the entities of the environment 100 configured to cause the respective subsystems/entity to perform the operations illustrated in the figures and discussed herein.

At block 200, a user of the TPS 102 may, via an interfaces generated by the I/O subsystem 110, select billing category. In this regard, the TPS 102 may have been previously supplied with a list of common billing categories, such as Utilities, Retail Merchandising, Bank, Car Dealers, Grocery, etc. The user may select for example the utility category. The selected category may be communicated to the back-end server. The back-end server 106 may respond with a list of organizations that belong to the selected category. For example, in the case of utilities, the back-end server 106 may response with the organizations Electric Co. and Gas Col.

At block 205, the organizations may be presented to the user via an interface. The user may then select and organization for which account information is desired. The selected organization may then be communicated to the back-end server 106.

The back-end server 106 may determine authentication requirements associated with the selected account server 104 that are in turn associated with the selected service provider. For example, in the case of Electric Co., the back-end server 106 may determine that two or more of the name on account, zip code for account holder, and SSN of account holder are required. The requirements may be communicated to the TPS 102.

At block 210, the TPS 102 may dynamically generate an interface based on the requirements for authenticating with the account server 104. For example, the TPS 102 may display an interface with input fields for providing the requirements. The interface may display an instruction such as “Please enter two or more of the following items.” The user may then specify as many required items as needed. The specified items may then be communicated to the back-end server 105.

At block 215, the back-end server 106 may subsequently determine that the required fields have been provided. If the required fields have been provided, the back-end server 106 may communicate the requirements to the account sever via one of the account server APIs. The account server 104 may then determine whether the requirements match any accounts on the account server 104, and if so, communicate a list of services provided by the account server 104. For example, the services may include checking an account balance, paying an account, and/or other services. The back-end server 106 may communicate a listing of the services to the TPS 102.

If the requirements do not match any accounts, the account server 104 may indicate this fact to the back-end server 106, which may in turn communicate this fact to the TPS 102. The TPS 102 may present an error message to the user in this case.

At block 220, the user may select a service, such as “Pay Bill.” The selection may be communicated to the back-end server 106.

At block 225, the back-end server 106 may request information related to the selected services from the account server 104. The requested service information may be communicated to the back-end server 106, which may then communicate the information to the TPS 102. For example, service information associated with a bill paying service may include the account balance, an amount due, the due date for paying the amount, previous transactions, etc.

At block 230, the user may elect to pay the amount due. For example, the amount due may be $75. In this case, the user may specify the amount to pay via an interface of the TPS 102. In addition or alternatively, the user may insert a corresponding amount of currency into the currency processing hardware 132 of the TPS 102. The TPS 102 may confirm that an adequate amount of currency has been inserted 132. Where excess funds have been provided, the TPS 102 may provide the user with change.

Once the TPS 102 determines that enough funds have been received, the TPS 102 may communicate and indication to back-end server that the amount of currency specified by the user has been deposited. The back-end server may forward this information to the account server, which may then mark the bill as having been paid, or may deduct the amount paid from the current balance.

The back-end server 106 may also communicate this information to the financial server 108 along with information that specifies the organization, the account number for which funds have been received, etc. The financial server 108 may then transfer funds at a later time to the organization.

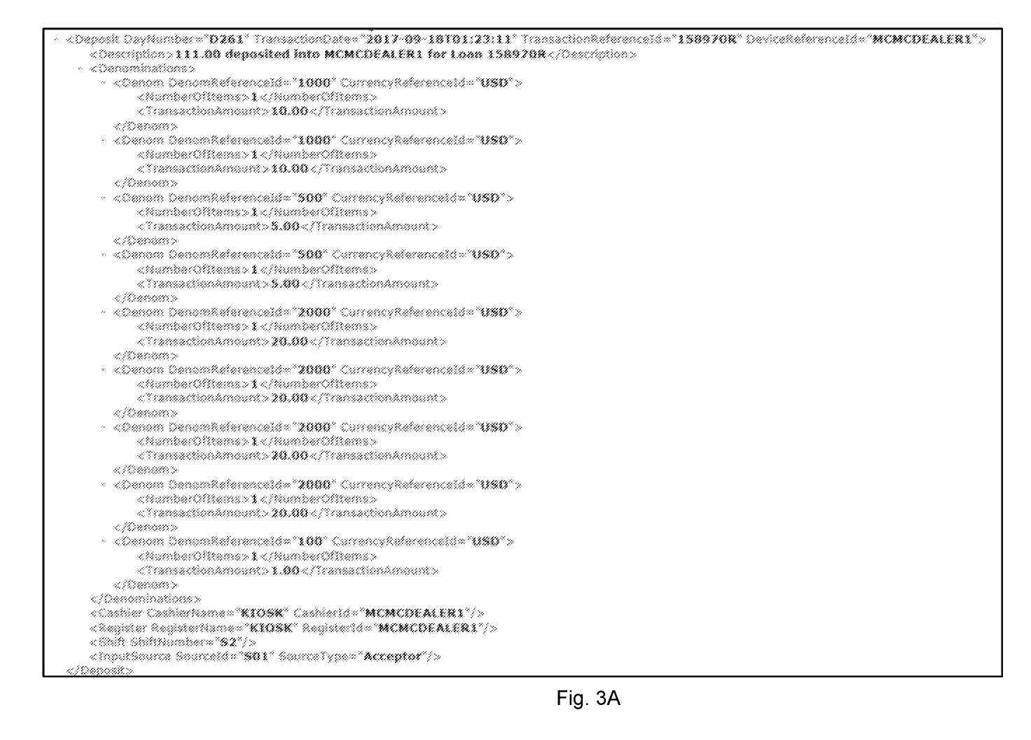

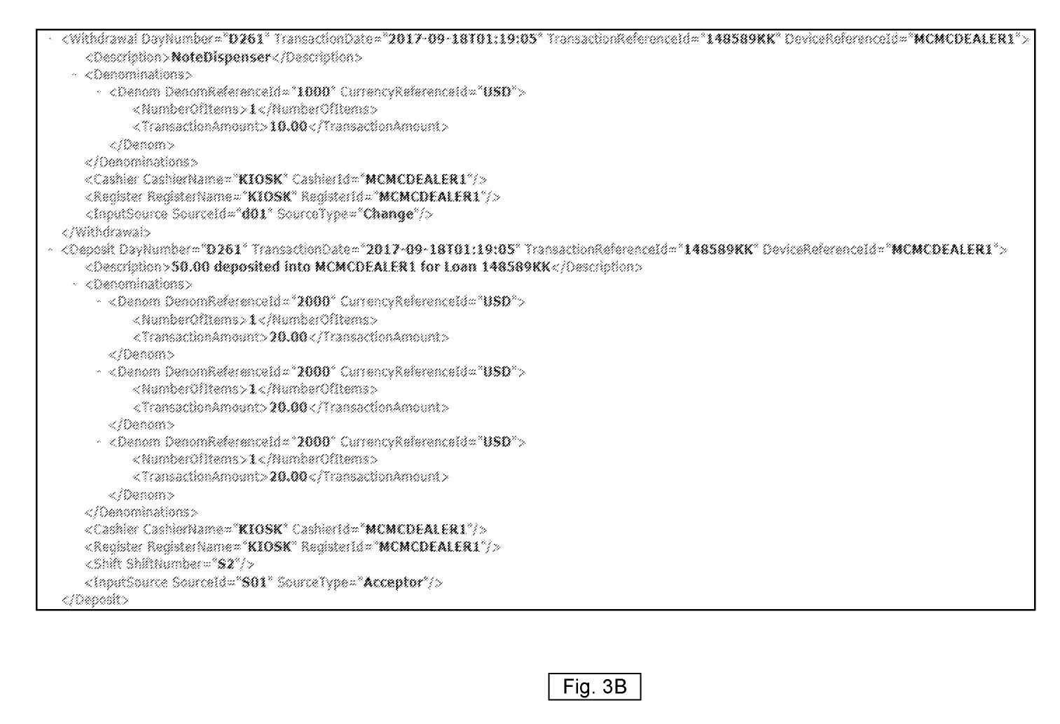

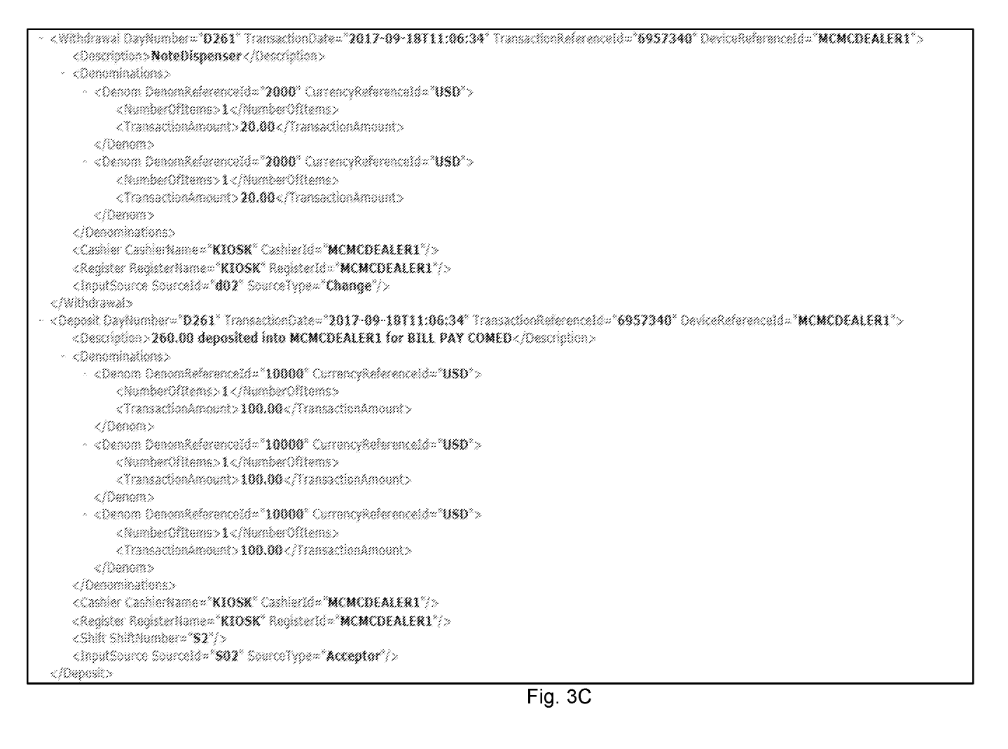

Exemplary transaction information that may be communicated by the TPS 102 during the operations described above is illustrated in FIGS. 3A-3B. The exemplary transactions are represented in an XML format. However, it is understood that the transaction information may be formatted differently (e.g., binary, JSON, text, etc.).

The first exemplary transaction of FIG. 3A may be generated under the following scenario: A customer may select a biller to be paid at operation 205. The customer may have previously provided identifying information at operation 210. Service information communicated to the customer after operation 225 may indicate a customer obligation such as a dollar amount owed to the biller. (e.g., $111). The customer may insert an exact amount owed into the currency processing hardware 132 of the TPS 102.

Upon posting the payment, the XML transaction of FIG. 3A may be generated and communicated to, for example, the back-end server 106. According to the exemplary transaction, the node “Deposit” includes attributes for a transaction date, a transaction reference ID, and a device reference ID that corresponds to an ID associated with the kiosk where the transaction was generated (i.e., MCMCDEALER1). A description child node may include a string description of the transaction such as “111.00 deposited into MCMCDEALER1 for Loan 158970R.” One or more child nodes are generated based on the amount of currency inserted into the currency processing hardware 132 of the TPS 102. For example, in this scenario the customer inserted two $10 notes, two $5 notes, four $20 notes, and one $1 note, for a total of $111. Other information that may be specified (but not shown) includes the biller ID (e.g., MCMC) customer account information, amount dispensed, if any, etc.

Upon completion of the transaction, the TPS 102 may generate a printed receipt of the transaction.

The second exemplary transaction of FIG. 3B may be generated under the following scenario: A customer may select a biller to be paid at operation 205. The customer may have previously provided identifying information at operation 210. Service information communicated to the customer after operation 225 may indicate a customer obligation such as a dollar amount owed to the biller. (e.g., $50). The customer may insert, for example, $60 into the currency processing hardware 132 of the TPS 102.

Upon posting the payment, the XML transaction of FIG. 3B may be generated and communicated to, for example, the back-end server 106. In this case, the transaction includes a Withdrawal node with one or more child nodes that indicate amount of change provided to the customer. For example, in this case, the customer received one $10 note in change.

The third exemplary transaction of FIG. 3C may be generated under the following scenario: A customer may select a biller to be paid at operation 205. The customer may have previously provided identifying information at operation 210. Service information communicated to the customer after operation 225 may indicate a customer obligation such as a dollar amount owed to the biller. (e.g., $260). The customer may insert, for example, $300 into the currency processing hardware 132 of the TPS 102.

Upon posting the payment, the XML transaction of FIG. 3B may be generated and communicated to, for example, the back-end server 106. In this case, the Withdrawal node indicates that two $20 notes were provided in change.

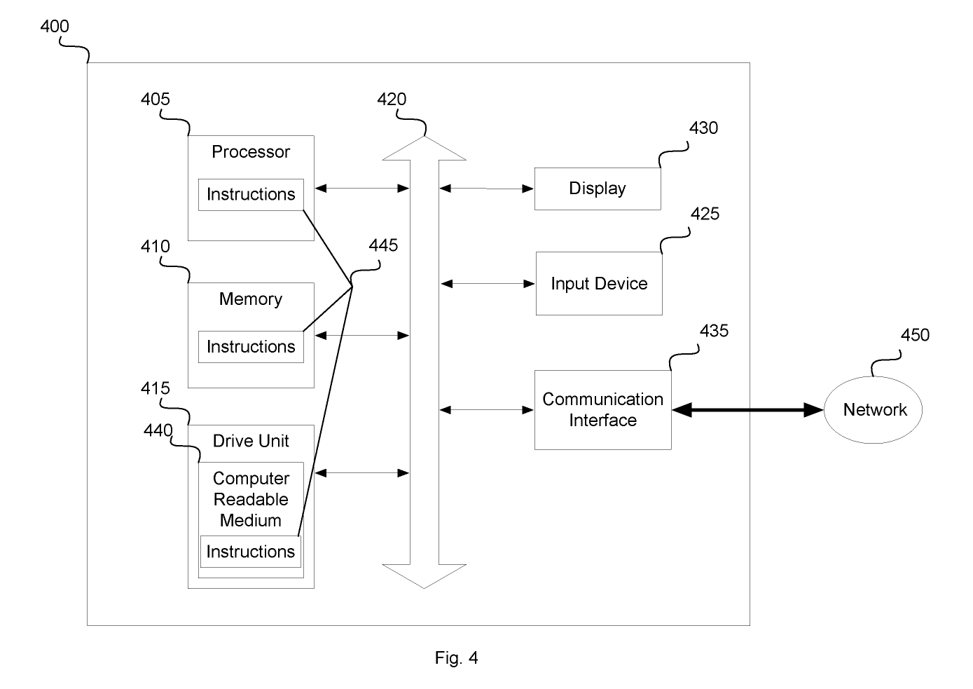

FIG. 4 illustrates a computer system 400 that may form part of or implement the systems, environments, devices, etc., described above. The computer system 400 may include a set of instructions 445 that the processor 405 may execute to cause the computer system 400 to perform any of the operations described above. The computer system 400 may operate as a stand-alone device or may be connected, e.g., using a network, to other computer systems or peripheral devices.

In a networked deployment, the computer system 400 may operate in the capacity of a server or as a client computer in a server-client network environment, or as a peer computer system in a peer-to-peer (or distributed) environment. The computer system 400 may also be implemented as or incorporated into various devices, such as a personal computer or a mobile device, capable of executing instructions 445 (sequential or otherwise) causing a device to perform one or more actions. Further, each of the systems described may include a collection of subsystems that individually or jointly execute a set, or multiple sets, of instructions to perform one or more computer operations.

The computer system 400 may include one or more memory devices 410 communicatively coupled to a bus 420 for communicating information. In addition, code operable to cause the computer system to perform operations described above may be stored in the memory 410. The memory 410 may be a random-access memory, read-only memory, programmable memory, hard disk drive or any other type of memory or storage device.

The computer system 400 may include a display 430, such as a liquid crystal display (LCD), a cathode ray tube (CRT), or any other display suitable for conveying information. The display 430 may act as an interface for the user to see processing results produced by processor 405.

Additionally, the computer system 400 may include an input device 425, such as a keyboard or mouse or touchscreen, configured to allow a user to interact with components of system 400.

The computer system 400 may also include a disk or optical drive unit 415. The drive unit 415 may include a computer-readable medium 440 in which the instructions 445 may be stored. The instructions 445 may reside completely, or at least partially, within the memory 410 and/or within the processor 405 during execution by the computer system 400. The memory 410 and the processor 405 also may include computer-readable media as discussed above.

The computer system 400 may include a communication interface 435 to support communications via a network 450. The network 450 may include wired networks, wireless networks, or combinations thereof. The communication interface 435 may enable communications via any number of communication standards, such as 802.11, 802.12, 802.20, WiMAX, cellular telephone standards, or other communication standards.

Accordingly, methods and systems described herein may be realized in hardware, software, or a combination of hardware and software. The methods and systems may be realized in a centralized fashion in at least one computer system or in a distributed fashion where different elements are spread across interconnected computer systems. Any kind of computer system or other apparatus adapted for carrying out the methods described herein may be employed.

The methods and systems described herein may also be embedded in a computer program product, which includes all the features enabling the implementation of the operations described herein and which, when loaded in a computer system, is able to carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation and b) reproduction of a first language, code, or notation.

While methods and systems have been described with reference to certain embodiments, it will be understood by those skilled in the art that various changes may be made and equivalents may be substituted without departing from the scope of the claims. Therefore, it is intended that the present methods and systems not be limited to the particular embodiment disclosed, but that the disclosed methods and systems include all embodiments falling within the scope of the appended claims.

We claim:

1. A terminal for processing transactions comprising:
a user interface configured to convey information to a user and to receive user commands;
currency processing hardware configured to receive currency from the user and to determine a type of currency accepted;
a processor in communication with the user interface and the currency processing hardware; and
non-transitory computer readable media in communication with the processor that stores instruction code which, when executed by the processor, causes the processor to:
receive, via the user interface, an account category selection;
communicate the account category selection to a back-end server;
receive, from the back-end server, a listing of one or more service providers associated with the account category selection;
convey on the user interface the listing of one or more service providers;
receive, via the user interface, a service provider selection;
communicate the service provider selection to a back-end server;
receive, from the back-end server, authentication requirements associated with an account server that is associated with the service provider selection;
convey on the user interface controls that facilitate specification of the authentication requirements by the user;
communicate requirements specified by the user to the back-end server, wherein in response, the back-end server communicates the requirements specified by the user to the account server, wherein in response to the back-end communication, the account server communicates a listing of one or more services provided by the account server to the back-end server;
receive, from the back-end server, the listing of one or more services provided by the account server;
receive, via the user interface, a service selection;
communicate the service selection to the back-end server, wherein in response, the back-end server communicates the service selection to the account server, wherein in response to the back-end communication, the account server communicates service information associated with the service selection to the back-end server;
receive, from the back-end server, the service selection;
receive, via the interface, an indication of an amount of currency to be paid;
receive currency via the currency processing hardware;
communicate to the back-end server, the amount of currency received, wherein in response, the back-end server communicates and indication of the amount of currency received to the account server.

2. The method according to claim 1, wherein the service providers correspond to one or more of: utility service providers, loan providers, retail establishment service providers, and government agencies.

3. The method according to claim 1, wherein the terminal corresponds to a kiosk.

4. The method according to claim 1, further comprising periodically communicating transaction information indicative of transactions processed on the terminal to a financial service provider to facilitate payments by the financial service provider to the service provider.

5. The method according to claim 1, wherein the authentication requirements correspond to one or more of: a name, zip code, and SSN associated with a user having an account with the selected servicer provider.

6. A method for processing a transaction comprising:
receiving, at a terminal and from a user, a selection of a service provider;
receiving authentication credential requirements associated with the selected service provider that facilitate authentication of the user by the service provider;
communicating, to the service provider account server, authentication credentials associated with the user that satisfy the authentication credential requirements;
when the user is authenticated, receiving, from the service provider account server, information indicative of an amount owed on an account with the service provider that is associated with the user;
receiving, via currency processing hardware of the terminal, currency; and
communicating transaction information to the service provider account server that indicates an amount of currency received by the terminal to thereby reduce the amount owed on the account by the user.

7. The method according to claim 6, wherein prior to receiving the selection of the service provider, the method comprises:
receiving, at a terminal and from a user, a selection of a service provider type; and
displaying, on the terminal, a listing of service providers that belong to the selected service provider type.

8. The method according to claim 6, wherein the service providers correspond to one or more of: utility service providers, loan providers, retail establishment service providers, and government agencies.

9. The method according to claim 6, wherein the terminal corresponds to a kiosk.

10. The method according to claim 6, further comprising periodically communicating transaction information indicative of transactions processed on the terminal to a financial service provider to facilitate payments by the financial service provider to the service provider.

11. The method according to claim 6, wherein the authentication credential requirements are communicated to the terminal from a back-end-server at a location different from the terminal.

12. The method according to claim 6, wherein the authentication requirements correspond to one or more of: a name, zip code, and SSN associated with a user having an account with the selected servicer provider.

13. The method according to claim 6, wherein when an amount of currency received by the terminal exceeds and amount owed on the account, the method comprises:
providing, by the terminal, an amount of currency that corresponds to a difference between the amount of currency received and the amount owed on the account.

14. A non-transitory computer readable medium that includes instruction code for processing a transaction, the instruction code is executable on a machine for causing the machine to perform acts comprising:
receiving, from a user, a selection of a service provider;
receiving authentication credential requirements associated with the selected service provider that facilitate authentication of the user by the service provider;
communicating, to the service provider account server, authentication credentials associated with the user that satisfy the authentication credential requirements;
when the user is authenticated, receiving, from the service provider account server, information indicative of an amount owed on an account with the service provider that is associated with the user;
receiving, via currency processing hardware of the machine, currency;
communicating transaction information to the service provider account server that indicates an amount of currency received by the machine to thereby reduce the amount owed on the account by the user;
when an amount of currency received by the machine exceeds and amount owed on the account, providing an amount of currency that corresponds to a difference between the amount of currency received and the amount owed on the account.

15. The non-transitory computer readable medium according to claim 14, wherein prior to receiving the selection of the service provider, the instruction code causes the machine to perform acts comprises:
receiving, from a user, a selection of a service provider type; and
displaying, on the machine, a listing of service providers that belong to the selected service provider type.

16. The non-transitory computer readable medium according to claim 14, wherein the service providers correspond to one or more of: utility service providers, loan providers, retail establishment service providers, and government agencies.

17. The non-transitory computer readable medium according to claim 14, wherein the machine corresponds to a kiosk.

18. The non-transitory computer readable medium according to claim 14, wherein the instruction code causes the machine to perform acts comprising periodically communicating transaction information indicative of transactions processed on the terminal to a financial service provider to facilitate payments by the financial service provider to the service provider.

19. The non-transitory computer readable medium according to claim 14, wherein the authentication credential requirements are communicated to the terminal from a back-end-server at a location different from the terminal.

20. The non-transitory computer readable medium according to claim 14, wherein the authentication requirements correspond to one or more of: a name, zip code, and SSN associated with a user having an account with the selected servicer provider.
